(19) United States
(12) Patent Application Publication
(10) Pub. No.: US 2023/0030000 A1
(43) Pub. Date: Feb. 2, 2023

(54) DECLARATIVE DEPLOYMENT OF A VIRTUAL INFRASTRUCTURE MANAGEMENT SERVER

(71) Applicant: VMWARE, INC., Palo Alto, CA (US)

(72) Inventors: Sandeep Sinha, Bangalore (IN); Ivaylo Radoslavov Radev, Sofia (BG); Akash Kodenkiri, Bangalore (IN); Ammar Rizvi, Bangalore (IN); Pradeep Jigalur, Bangalore (IN); Niharika Narasimhamurthy, Bangalore (IN); Anmol Parikh, Bangalore (IN); Chandrika Mutalik, Bangalore (IN)

(21) Appl. No.: 17/464,733

(22) Filed: Sep. 2, 2021

(30) Foreign Application Priority Data
Jul. 20, 2021 (IN) 202141032713

(51) Int. Cl. G06F 9/4401; G06F 9/455; G06F 8/61

(52) U.S. Cl. CPC G06F 9/4403; G06F 9/45558; G06F 8/61; G06F 2009/45562

(57) ABSTRACT

Techniques for declaratively deploying a virtual infrastructure management (VIM) server in a computing environment are provided. According to one set of embodiments, an installer computer system can receive a desired state definition specifying a desired state for the VIM server and a virtual infrastructure to be managed by the VIM server. The installer computer system can further install the VIM server on a target computer system in the computing environment and provide the desired state definition to the target computer system. Upon initial boot up of the VIM server on the target computer system, a service of the VIM server can automatically configure the VIM server in accordance with the desired state definition.

### RELATED APPLICATION

Benefit is claimed under 35 U.S.C. 119(a)-(d) to Foreign Application Serial No. 202141032713 filed in India entitled “DECLARATIVE DEPLOYMENT OF A VIRTUAL INFRASTRUCTURE MANAGEMENT SERVER”, on Jul. 20, 2021, by VMware. Inc., which is herein incorporated in its entirety by reference for all purposes.

### BACKGROUND

Unless otherwise indicated, the subject matter described in this section is not prior art to the claims of the present application and is not admitted as being prior art by inclusion in this section.

A virtual infrastructure is a collection of software-defined components (e.g. virtual compute resources, virtual storage resources, virtual networking resources, etc.) that make up an organization's information technology (IT) environment. A virtual infrastructure management (VIM) server is a software platform that is used to centrally manage and configure a virtual infrastructure. Examples of existing VIM server products include SolarWinds VMAN. Veeam ONE, Nutanix AOS, and VMware vCenter Server.

Currently, the process of deploying a VIM server is often complex, time-consuming, and involves a significant amount of manual intervention on the part of infrastructure administrators. Accordingly, it would be desirable to have techniques for facilitating this process.

### BRIEF DESCRIPTION OF THE DRAWINGS

FIG. 1 depicts an example computing environment and conventional VIM server deployment process.

FIG. 2 depicts an enhanced version of the computing environment of FIG. 1 and a VIM server deployment process according to certain embodiments.

FIGS. 3A and 311 depict a flowchart of a VIM server deployment process according to certain embodiments.

### DETAILED DESCRIPTION

in the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

The present disclosure is directed to techniques for deploying a VIM server in a declarative manner (or in other words, via a desired state definition that indicates the desired state of the VIM server and the virtual infrastructure components it is configured to manage). The desired state definition can be provided by an administrator or other user/agent at the time of initiating the deployment and can specify the topology of the VIM server's virtual infrastructure (e.g., the number and hierarchy of datacenter, cluster, and host components), the features/properties of the VIM server and each virtual infrastructure component, and other related information.

With this declarative approach, the complexities and manual steps required by conventional approaches for deploying a VIM server can be largely mitigated or avoided, resulting in a more streamlined, intuitive, and user-friendly deployment process.

### 2. Example Computing Environment and High-Level Solution Description

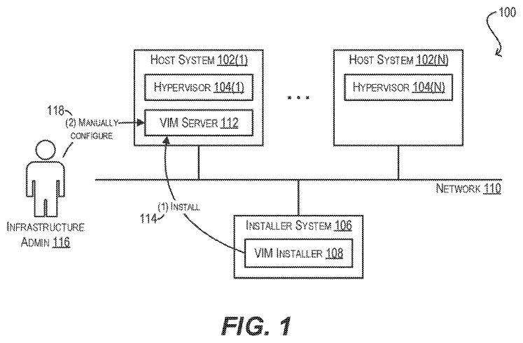

FIG. 1 is a simplified block diagram of an example computing environment 100 in which embodiments of the present disclosure may be implemented. As shown, computing environment 100 includes a number of physical host systems 102(1)-(N) running hypervisors 104(1)-(N) and an installer system 106 running a VIM installer 108. Host systems 102(1)-(N) and installer system 106 are interconnected via a network 110 such as a local area or wide area network.

Generally speaking, the purpose of VIM installer 108 is to deploy an instance of a VIM server 112 within computing environment 100 in order to manage the physical resources of environment 100, including host systems 102(1)-(N), as a virtual infrastructure. With current approaches, this deployment process typically involves installing VIM server 112 on a particular host system of computing environment 100 (e.g., host system 102(1), shown via step (1)/reference numeral 114) and prompting an infrastructure administrator 116 to manually configure VIM server 112 after its installation in order to setup the various features/properties of VIM server 112 and its inventory of virtual infrastructure components (shown via step (2)/reference numeral 118).

As noted in the Background section, the conventional deployment process illustrated in FIG. 1 is undesirable for several reasons; it is time-consuming, complex, and requires infrastructure administrators to manually drive significant portions of the process. These issues are particularly problematic for very large-scale virtual infrastructures, which are becoming increasingly common as organizations move towards this IT paradigm.

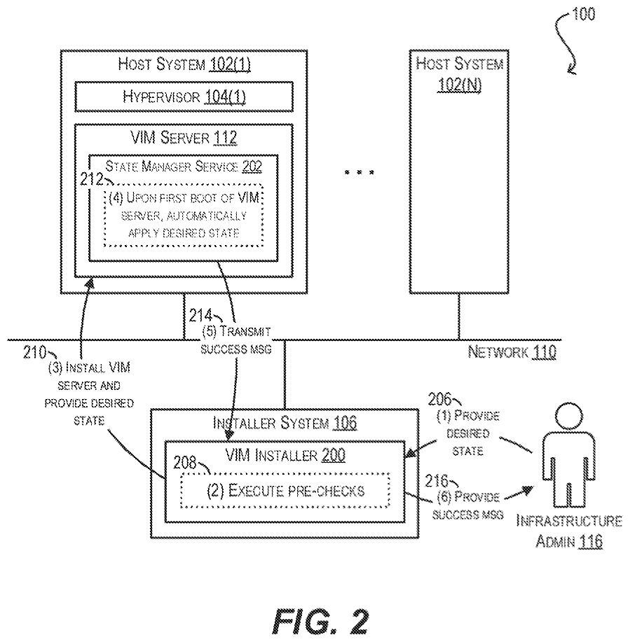

To address the foregoing and other similar issues, FIG. 2 depicts a modified version of computing environment 100 that includes an enhanced VIM installer 200 on installer system 106 and a state manager service 202 within VIM server 112. At a high level, VIM installer 200 and state manager 202 can carry out a novel workflow for deploying VIM server 112 that comprises (a) receiving, by VIM installer 200 from infrastructure administrator 116 (or some other user or agent), a desired state definition for VIM server 112 that specifies, among other things, the topology of the virtual infrastructure to be managed by VIM server 112 and the desired features/properties of VIM server 112 and each virtual infrastructure component (step (1), reference numeral 206); (b) executing, by VIM installer 200, a number or validations (i.e., “pre-checks”) to ensure that the deployment can be completed successfully in view of the desired state definition (step (2), reference numeral 208); (c) installing, by VIM installer 200, VIM server 112 on a target host system (e.g., host system 102(1)) and providing, as part of the installation, the desired state definition to state manager 202/VIM server 112 (step (3), reference numeral 210); (d) upon initial boot of VIM server 112 on the target host system, parsing, by state manager 202, the desired state definition and automatically applying the state specified therein to the configuration of VIM server 112 (step (4), reference numeral 212); (e) transmitting, by state manager 202, a message to VIM installer 200 indicating that VIM server 112 has been successfully deployed based on the desired state definition (step (5), reference numeral 214); and (f) forwarding, by VIM installer 200, that message (or a similar confirmation message) to infrastructure administrator 116 (step (6), reference numeral 216).

With the high-level deployment approach shown in FIG. 2 and described above, there is no need for infrastructure administrator 116 to intervene in the deployment process and manually setup/configure aspects of VIM server 112 as part of that process. Instead, administrator 116 can simply provide all of the desired attributes of VIM server 112 and its virtual infrastructure (including its topology, supported features, security requirements, etc.) declaratively via the desired state definition, and VIM installer 200/state manager 202 can automatically drive the deployment of VIM server 112 to completion in accordance with the provided definition. Accordingly, this approach significantly simplifies and streamlines the deployment process, thereby reducing the administrative burden on existing users/customers of the platform and encouraging its adoption by new users/customers.

The remainder of this disclosure provides additional details for implementing the deployment workflow shown in FIG. 2 according to certain embodiments, including steps for deploying an image file of VIM server 112 on a new hyper-converged infrastructure (CI) datastore prior to its installation and setting/enabling various virtual infrastructure features such as high availability (HA), host lifecycle management, and so on. It should be appreciated that FIGS. 1 and 2 are illustrative and not intended to limit embodiments of the present disclosure. For example, although FIGS. 1 and 2 depicts a particular arrangement of entities/components within computing environment 100, other arrangements are possible (e.g., the functionality attributed to a particular component may be split into multiple components, components may be combined, etc.). Further, the various components shown may include sub-components and/or functions that are not specifically described. One of ordinary skill in the art will recognize other variations, notifications, and alternatives.

### 3. Deployment Flowchart

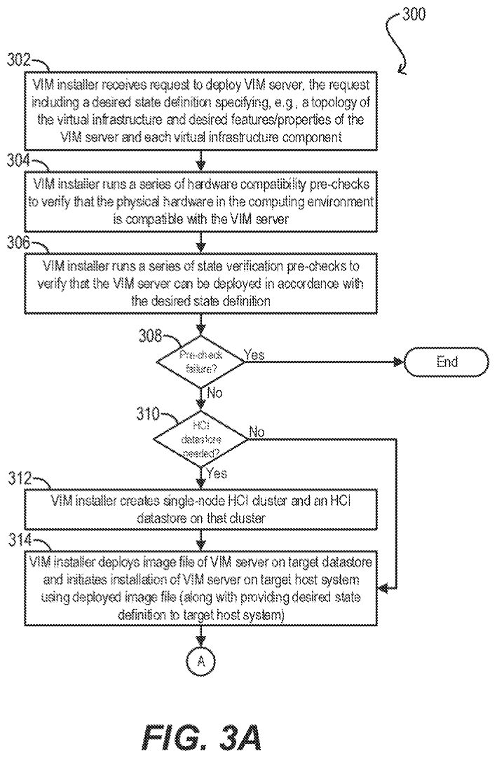

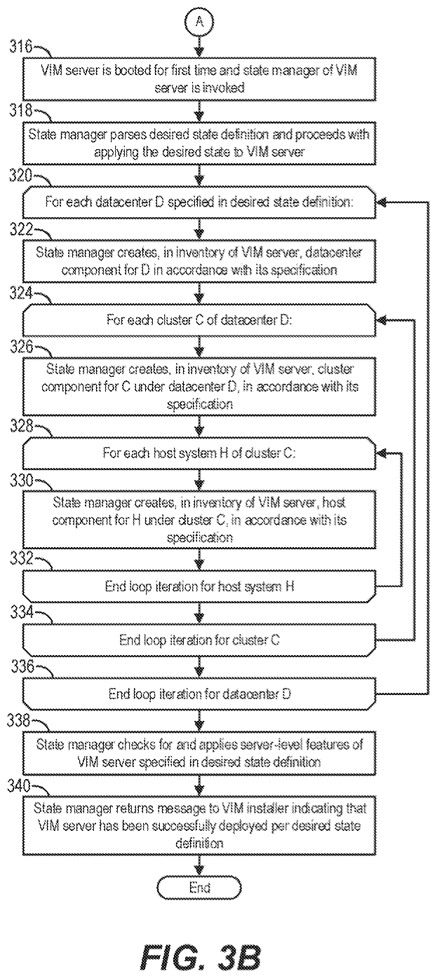

FIGS. 3A and 3B depict a flowchart 300 that describes in greater detail the steps that may be performed by VIM installer 200 and state manager 202 of FIG. 2 for deploying VIM server 112 in computing environment 100 according to certain embodiments. As used herein, the process of “deploying a VIM server” in a computing environment comprises installing an instance of the VIM server on a physical machine of that computing environment and configuring the VIM server's internal state (including, e.g., its inventory of virtual infrastructure components) to manage the computing environment's physical resources in the form of a virtual infrastructure.

Starting with block. 302 of FIG. 3A, VIM installer 200 can receive from infrastructure administrator 116 (or another user or an automated agent), a request to deploy VIM server 112 in computing environment 100, the request including a desired state definition that specifies, in a declarative format, a desired state for VIM server 112 and the virtual infrastructure which VIM server 112 is configured to manage. For example, the desired state definition can specify the number of datacenters, clusters, and host systems to be managed by VIM server 112 and the hierarchy of these virtual infrastructure components (e.g., the clusters to be included in each datacenter, the host systems to be included in each cluster, etc.). A “datacenter” in this context is a logical container that aggregates the various components needed to run a virtual infrastructure, such as clusters, hosts, network resources, storage resources (e.g., datastores), and so on. A “cluster” is a logical grouping of host systems.

The desired state definition can also specify other types of information, such as the desired properties and features of VIM server 102 (e.g., name, security permissions, standalone hosts, target datastore for installation, whether HA is enabled, etc.) and the desired properties and features of each datacenter/cluster/host system in the virtual infrastructure topology (e.g., name, security permissions, whether host lifecycle management is enabled, whether HCI storage is enabled, whether HA is enabled, whether container management support (e.g., Kubernetes) is enabled, etc.). HCI storage refers to a storage paradigm in which the local storage resources of a cluster's host systems are aggregated into a virtual storage pool and made available for use by the cluster's storage clients (e.g., virtual machines (VMs) or containers). One example implementation of HCI storage is VMware vSAN.

Listing 1 below is a sample representation of the desired state definition that can be received by VIM installer 200 at block 302, formatted using JSON (JavaScript Object Notation):

```
{
  “desired_state”: {
    “datacenters”: [
    {
      “permissions”: [ ],
      “name”: “SDDC-Datacenter”,
      “parent_path”: “Datacenters”,
      “standalone_hosts”: [ ]
    }]
    “clusters”: [
    {
      “hosts”: [
        “10.2.32.4”,
        “10.2.32.6”,
        “10.2.32.5”,
        “10.2.32.8”,
        “10.2.32.7”
      ],
      “permissions”: [ ],
      “name”: “Cluster-1”,
      “ha”: {
        “enabled”: true,
      },
      “parent_path”: “Datacenters/SDDC-Datacenter/host”,
      “proactive_ha”: {
        “enabled”: false,
        “providers”: [ ]
      },
      “vsan”: {
        “default_config”: {
          “checksum_enabled”: true
        },
        “enabled”: true
      },
      “ha_vm_overrides”: [ ]
    }]
  }
}
```

### Listing 1

At block 304, VIM installer 200 can run a series of hardware compatibility pre-checks to verify whether the physical hardware in computing environment 100 (e.g., the hardware of host systems 102(1)-(N)) is compatible with the version of VIM server 112 to be deployed. These hardware compatibility pre-checks can include. e.g., checking whether the firmware of host systems 102(1)-(N) is compatible with VIM server 112, whether each host system 102(1)-(N) meets a minimum system specification (in terms of, e.g., CPU resources, memory resources, etc.), and more.

In addition, at block 306, VIM installer 200 can run a series of state verification pre-checks to verify whether the desired state definition received at block 302 can be successfully deployed in computing environment 100. These state verification pre-checks can include verifying that the syntax and parameter values included in the desired state definition are valid. The state verification pre-checks can also include verifying whether the hardware of computing environment 100 meets certain minimum requirements for the features specified/enabled in the desired state definition.

For example, if the desired state definition indicates that that host lifecycle management should be enabled for a cluster comprising host systems 102(1), 102(2), and 102(3), VIM installer 200 can check whether host systems 102(1)-(3) have an appropriate version of hypervisor 104 installed to support this feature. As another example, if the desired state definition indicates that HCI storage should be enabled for a cluster comprising host systems 102(3), 102(4), and 102(5), VIM installer 200 can check whether host systems 102(3)-(5) have appropriate local storage devices installed (e.g., one or more solid-state disks (SSDs) for a cache tier of the HCI storage and one or more capacity disks for a capacity tier of the HCI storage).

If any of the pre-checks at blocks 304 and 306 fail (block 310), VIM installer 200 can terminate the deployment process and flowchart 300 can end. However, if all of the pre-checks are successful, VIM installer 200 can further check whether the desired state definition indicates that an HCI datastore (i.e., a datastore that resides on the HCI storage layer of a cluster) is needed for installing VIM server 112 (block 310). If the answer is yes, VIM installer 200 can invoke a management function for creating a single-node I-ICI cluster in computing environment 100 and an HCI datastore on that cluster (block 312).

Upon completing the check at block 310, VIM installer 200 can deploy an image file for VIM server 112 onto a target datastore (e.g., the HCI datastore created at block 312) and initiate installation of VIM server 112 on a target host system (e.g., host system 102(1)) using the deployed image file (block 314). As part of this process, VIM installer 200 can provide the desired state definition to the target host system, either directly or via the target datastore. In a particular embodiment, the image file for VIM server 112 can be an OVA (Open Virtual Appliance) file and VIM server 112 can be installed as a VM-based virtual appliance on the target host system.

Turning now to FIG. 3B, once VIM server 112 has been installed, one or more scripts can be used to boot the server for the first time and to invoke the server's state manager 202 (block 316). In response to being invoked, state manager 202 can parse the desired state definition provided by VIM installer 200 and proceed with applying the desired state specified therein to VIM server 112 (block 318). For example, at blocks 320 and 322, state manager 202 can enter a loop for each datacenter D specified in the desired state definition and create a datacenter component in the virtual infrastructure inventory of VIM server 112 in accordance with datacenter D's specification.

Further, at blocks 324 and 326, state manager 202 can enter a loop for each cluster C of datacenter D specified in the desired state definition and create a cluster component in the virtual infrastructure inventory of VIM server 112 (under datacenter ID) in accordance with cluster C's specification. As part of block 326, state manager 202 can interact with other services of VIM server 112 as needed in order to ensure that cluster C's desired state is applied/created properly. For example, if the desired state for cluster C indicates that host lifecycle management should be enabled for the cluster, state manager 202 can interact with a lifecycle management service of VIM server 112 to ensure that the characteristics of the host systems in C are consistent per lifecycle management policies. As another example, if the desired state for cluster C indicates that a container management control plane (e.g., Kubernetes) should be enabled for the cluster, state manager 202 can interact with a container manager service of VIM server 112 to ensure that such a control plane is created for the cluster. As yet another example, if the desired state for cluster C indicates that HA should be enabled, state manager 202 can interact with an HA service of VIM server 112 to ensure that appropriate HA components are created in the cluster.

Yet further, at blocks 328 and 330, state manager 202 can enter a loop for each host system H of cluster C specified in the desired state definition and create a host component in the virtual infrastructure inventory of VIM server 112 (under cluster C) in accordance with host system H's specification. This host component is an entry in the inventory that identifies existing host system H and its properties (e.g., network address, etc.).

Upon completing, the creation of the datacenter, cluster, and host components (blocks 332, 334, and 336), state manager 202 can check for and apply any server-level features of VIM server 112 specified in the desired state definition (block 33S). For example, if HA is enabled for VIM server 112, state manager 202 can deploy another instance of VIM server 112 on a different host system 102 of computing environment 100 and configure that new server instance as a backup VIM server for HA purposes.

Finally, at block 340, state manager can return a message to VIM installer 200 indicating that VIM server 112 has been successfully deployed in accordance with the desired state definition and flowchart 300 can end. Although not shown here, VIM installer 200 can subsequently provide a deployment confirmation to the entity that initiated the deployment process (e.g., infrastructure administrator 116). Further, if any errors or failures occur during the installation of VIM server 112 or the creation/application of its desired state per blocks 314-338, a deployment failure message can be generated for review by that entity.

Yet further, in some scenarios VIM installer 200 may be configured to perform a batch deployment of multiple instances of VIM server 112. In these scenarios, VIM installer 200 and state manager 202 can repeat workflow 300 for each server instance to be deployed, either in a serial or parallel fashion.

Certain embodiments described herein can employ various computer-implemented operations involving data stored in computer systems. For example, these operations can require physical manipulation of physical quantities-usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Yet further, one or more embodiments can relate to a device or an apparatus for performing the foregoing operations. The apparatus can be specially constructed for specific required purposes, or it can be a general-purpose computer system selectively activated or configured by program code stored in the computer system. In particular, various general-purpose machines may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any data storage device that can store data which can thereafter be input to a computer system. The non-transitory computer readable media may be based on any existing or subsequently developed technology for embodying computer programs in a manner that enables them to be read by a computer system. Examples of non-transitory computer readable media include a hard drive, network attached storage (NAS), read-only memory, random-access memory, flash-based nonvolatile memory (e.g., a flash memory card or a solid-state disk), a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

In addition, while certain virtualization methods referenced herein have generally assumed that virtual machines present interfaces consistent with a particular hardware system, persons of ordinary skill in the art will recognize that the methods referenced can be used in conjunction with virtualizations that do not correspond directly to any particular hardware system. Virtualization systems in accordance with the various embodiments, implemented as hosted embodiments, non-hosted embodiments or as embodiments that tend to blur distinctions between the two, are all envisioned. Furthermore, certain virtualization operations can be wholly or partially implemented in hardware.

Many variations, modifications, additions, and improvements are possible, regardless the degree of virtualization. The virtualization software can therefore include components of a host, console, or guest operating system that performs virtualization functions. Plural instances can be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method for deploying a virtual infrastructure management (VIM) server in a computing environment, the method comprising:
receiving, by an installer computer system, a desired state definition specifying a desired state for the VIM server and a virtual infrastructure to be managed by the VIM server;
installing, by the installer computer system, the VIM server on a target computer system in the computing environment; and
providing, by the installer computer system, the desired state definition to the target computer system,
wherein upon initial boot up of the VIM server on the target computer system, a service of the VIM server automatically configures the VIM server in accordance with the desired state definition.

2. The method of claim 1, wherein the desired state definition specifies a topology of the virtual infrastructure, the topology including one or more datacenters, one or more clusters, and one or more host systems.

3. The method of claim 2 wherein the desired state definition further specifies one or more desired features or properties for the VIM server, the one or more datacenters, the one or more clusters, and the one or more host systems.

4. The method of claim 3 wherein the one or more desired features or properties include enablement of high availability for the VIM server.

5. The method of claim 3 wherein the one or more desired features or properties for include enablement of hyper-converged infrastructure (HCI) storage for at least one cluster.

6. The method of claim 2 wherein automatically configuring the VIM server in accordance with the desired state definition comprises:
for each of the one or more datacenters, the one or more clusters, and the one or more host systems included in the topology, creating a corresponding component in a virtual infrastructure inventory maintained by the VIM server.

7. The method of claim 1 further comprising, prior to the installing:
performing, by the installer computer system, a plurality of validations for verifying that the VIM server can be successfully deployed in the computing environment, the plurality of validations including:
one or more first validations for verifying correctness of the desired state definition; and
one or more second validations for verifying compatibility of physical hardware of the computing environment with the VIM server and the desired state definition.

8. A non-transitory computer readable storage medium having stored thereon program code executable by an installer computer system, the program code embodying a method for deploying a virtual infrastructure management (VIM) server in a computing environment, the method comprising:
receiving a desired state definition specifying a desired state for the VIM server and a virtual infrastructure to be managed by the VIM server;
installing the VIM server on a target computer system in the computing environment; and
providing the desired state definition to the target computer system,
wherein upon initial boot up of the VIM server on the target computer system, a service of the VIM server automatically configures the VIM server in accordance with the desired state definition.

9. The non-transitory computer readable storage medium of claim 8 wherein the desired state definition specifies a topology of the virtual infrastructure, the topology including one or more datacenters, one or more clusters, and one or more host systems.

10. The non-transitory computer readable storage medium of claim 9 wherein the desired state definition further specifies one or more desired features or properties for the VIM server, the one or more datacenters, the one or more clusters, and the one or more host systems.

11. The non-transitory computer readable storage medium of claim 10 wherein the one or more desired features or properties include enablement of high availability for the VIM server.

12. The non-transitory computer readable storage medium of claim 10 wherein the one or more desired features or properties for include enablement of hyper-converged infrastructure (HCI) storage for at least one cluster.

13. The non-transitory computer readable storage medium of claim 9 wherein automatically configuring the VIM server in accordance with the desired state definition comprises:
for each of the one or more datacenters, the one or more clusters, and the one or more host systems included in the topology, creating a corresponding component in a virtual infrastructure inventory maintained by the VIM server.

14. The non-transitory carputer readable storage medium of claim 8 wherein the method further comprises, prior to the installing:
performing a plurality of validations for verifying that the VIM server can be successfully deployed in the computing environment, the plurality of validations including:
one or more first validations for verifying correctness of the desired state definition; and
one or more second validations for verifying compatibility of physical hardware of the computing environment with the VIM server and the desired state definition.

15. A computer system comprising:
a processor; and
a non-transitory computer readable medium having stored thereon program code for deploying a virtual infrastructure management (VIM) server, the program code causing the processor to:
receive a desired state definition specifying a desired state for the VIM server and a virtual infrastructure to be managed by the VIM server;
install the VIM server on another computer system; and
provide the desired state definition to said another computer system,
wherein upon initial boot up of the VIM server on said another computer system, a service of the VIM server automatically configures the VIM server in accordance with the desired state definition.

16. The computer system of claim 15 wherein the desired state definition specifies a topology of the virtual infrastructure, the topology including one or more datacenters, one or more clusters, and one or more host systems.

17. The computer system of claim 16 wherein the desired state definition further specifies one or more desired features or properties for the VIM server, the one or more datacenters, the one or more clusters, and the one or more host systems.

18. The computer system of claim 17 wherein the one or more desired features or properties include enablement of high availability for the VIM server.

19. The computer system of claim 17 wherein the one or more desired features or properties for include enablement of hyper-converged infrastructure (HCI) storage for at least one cluster.

20. The computer system of claim 16 wherein the service automatically configures the VIM server in accordance with the desired state definition by:
creating, for each of the one or more datacenters, the one or more clusters, and the one or more host systems included in the topology, a corresponding component in a virtual infrastructure inventory maintained by the VIM server.

21. The computer system of claim 15 wherein the program code further causes the processor to, prior to installing the VIM server on said another computer system:
perform a plurality of validations for verifying that the VIM server can be successfully deployed in the computing environment, the plurality of validations including:
one or more first validations for verifying correctness of the desired state definition; and
one or more second validations for verifying compatibility of physical hardware of the computing environment with the VIM server and the desired state definition.
